(19) United States
(12) Patent Application Publication
(10) Pub. No.: US 2005/0244078 A1
(43) Pub. Date: Nov. 3, 2005

(54) Photographic slides having specified transmission functions

(76) Inventors: Simon Magarill, Cincinnati, OH (US); Edward L. Jones, Cincinnati, OH (US)

Correspondence Address: 3M INNOVATIVE PROPERTIES COMPANY, PO BOX 33427, ST. PAUL, MN, 55133-3427, US

(21) Appl. No.: 10/833,623

(22) Filed: Apr. 28, 2004

(51) Int. Cl. G03B 41/00

(52) U.S. Cl. 382/274

(57) ABSTRACT

Methods for producing photographic slides having specified transmission functions are provided in which an image on a computer screen is iteratively adjusted so that a photographic image of the screen when developed has the desired transmission function to within a user-specified criterion. Photographic slides suitable for use in determining a three dimensional configuration of an object, e.g., a patient's tooth, are also disclosed.

### FIELD OF THE INVENTION

This invention relates to photographic slides having specified transmission functions and to methods for making such slides. In certain embodiments, the specified transmission function is periodic.

One application of the invention is in the field of projection optical systems, and, in particular, projection optical systems used in three-dimensional imaging technology. In connection with this application, the photographic slides of the invention can be used to create desired light distribution patterns on a target plane or target object such as a patient's tooth.

### BACKGROUND OF THE INVENTION

U.S. patent Publication No. US 2003/0223083 entitled “Method and Apparatus for Generating Structural Pattern Illumination,” which was published on Dec. 4, 2003 and names Z. Jason Geng as inventor, discloses three-dimensional imaging methods in which patterns of colored lights are projected onto an object which is to be imaged. Various patterns are disclosed in this patent publication, including patterns in which the intensity of a projected colored light varies periodically across the surface of the object to be imaged. As shown in FIGS. 7b, 11, 13, and 15 of the publication, a preferred pattern is one in which, within each period, the intensity of a projected colored light varies substantially linearly between its minimum and maximum values.

The use of photographic film in optical systems which produce colored light patterns on an object is disclosed in Liu et al., “Color-coded projection grating method for shape measurement with a single exposure,” Applied Optics, 2000, 39:3504-3508, and Jeong et al., “Color grating projection moire with time-integral fringe capturing for high-speed 3-D imaging,” Optical Engineering, 2002, 41:1912-1917. However, neither of these references contain information as to the nature of the image recorded on the photographic film or whether the film conformed to specified transmission criteria.

The use of a linear variable wavelength filter (LVWF) formed on a glass plate to form three-dimensional images of objects is disclosed in Geng, Z. Jason, “Rainbow three-dimensional camera: new concept of high-speed three-dimensional vision systems,” Optical Engineering, 1996, 35:376-383. As described therein, the wavelength of light transmitted through the LVWF varies linearly with position along the filter, the linearity being better than 1% as measured by the filter's manufacturer (see page 379).

As discussed in U.S. patent Publication No. US 2003/0223083 referred to above, it is difficult to adjust the spectral variation rate of a LVWF to fit the accuracy requirements of many three-dimensional imaging tasks. As also acknowledged in this reference, the technology used to date to produce LVWF's have made such filters difficult and expensive to manufacture. In addition, due to manufacturing limitations, LVWF's have a relatively large footprint which make them difficult to incorporate in handheld devices.

Instead of a LVWF, three dimensional imaging systems that rely on the dispersion of an optical prism or a diffraction grating to produce illumination which varies spatially as a function of wavelength have also been disclosed. These approaches require expensive components and cannot be produced in a small envelope. They thus do not overcome the problems associated with the LVWF approach.

### SUMMARY OF THE INVENTION

In accordance with a first aspect, the invention provides a method for producing a photographic slide using a computer screen having a plurality of pixels, said photographic slide comprising a user-specified type of photographic film (e.g., a user-specified type of positive or negative color film or a user-specified type of positive or negative black and white film) developed by a user-specified developing process (e.g., a commercially available developing process, such as, a developing process available to retail consumers, or a customized developing process, provided that in each case, the process is substantially identical each time it is used), said method comprising:
(A) generating a brightness pattern on the computer screen by selecting red, green, and blue brightness values for the pixels of the screen;
(B) exposing the user-specified type of photographic film to the brightness pattern using a user-specified set of exposure conditions (e.g., the same camera location relative to the computer screen, the same camera settings, and the same ambient lighting conditions);
(C) developing the exposed photographic film using the user-specified developing process;
(D) measuring the transmission function of the exposed and developed photographic film (e.g., using a commercially available densitometer);
(E) comparing the measured transmission function to a desired transmission function (e.g., a transmission function which has repeating linear zones or sections) and generating an adjusted brightness pattern on the computer screen based on said comparison;
(F) iterating steps (B) through (E) using the adjusted brightness pattern of step (E) as the brightness pattern of step (B) to identify a final brightness pattern for which the difference between the measured transmission function and the desired transmission function satisfies a user-specified criterion; and
(G) using the final brightness pattern to produce the photographic slide.

In certain embodiments of this aspect of the invention:
(i) the user-specified type of photographic film is color film,
(ii) the desired transmission function comprises a desired red transmission function, a desired green transmission function, and a desired blue transmission function, and
(iii) for each iteration:
   (a) the user-specified type of photographic film is exposed in step (B) to red, green, and blue brightness patterns,
   (b) separate red, green, and blue transmission functions are measured for the developed film in step (D),
   (c) separate comparisons and adjusted red, green, and blue brightness patterns are generated in step (E), and
   (d) separate red, green, and blue final brightness patterns are identified in step (F).

In certain embodiments, the final brightness pattern or patterns can be used to produce a plurality of photographic slides, e.g., the final brightness pattern(s) can be used in a manufacturing setting to produce photographic slides which are subsequently incorporated in 3D imaging systems.

As used herein, the phrase “user-specified” contemplates both specification prior to commencement of the method or at any point during the performance of the method, and includes changes to a specification during performance, e.g., changes to the user-specified criterion of step (F) after one or more iterations.

In accordance with a second aspect, the invention provides a photographic slide having a measured transmission function which:
(i) comprises at least two periods; and
(ii) for at least 85 percent of each period (preferably, at least 90 percent), is linear to within 3 percent (preferably to within 2 percent).

In accordance with a third aspect, the invention provides a photographic slide having a red measured transmission function, a green measured transmission function, and a blue measured transmission function, each of which:
(i) comprises at least two periods; and
(ii) for at least 85 percent of each period (preferably, at least 90 percent), is linear to within 3 percent (preferably to within 2 percent).

In connection with certain preferred embodiments of this aspect of the invention, the periods of the red, green, and blue measured transmission functions are (i) the same and (ii) are phase shifted relative to one another by one-third of a period.

In accordance with a fourth aspect, the invention provides a set of three photographic slides wherein:
(A) each slide has a measured transmission function which:
   (i) comprises at least two periods; and
   (ii) for at least 85 percent of each period (preferably, at least 90 percent), is linear to within 3 percent (preferably to within 2 percent);
(B) the periods of the three slides are the same; and
(C) the measured transmission functions of the slides are phase shifted by one-third of a period.

In accordance with each of the foregoing aspects of the invention, the measured transmission function can have a triangular shape of the type shown in FIG. 6.

Additional features and advantages of the invention are set forth in the detailed description which follows, and in part will be readily apparent to those skilled in the art from that description or recognized by practicing the invention as described herein.

It is to be understood that both the foregoing general description and the following detailed description are merely exemplary of the invention, and are intended to provide an overview or framework for understanding the nature and character of the invention.

### BRIEF DESCRIPTION OF THE DRAWINGS

FIG. 1 is a schematic drawing of an optical system which can be used to produce a desired light pattern on an object using one or more of the photographic slides of the invention.

FIG. 2 is a schematic drawing illustrating the preparation of a photographic slide having a sinusoidal transmission function.

FIG. 3a illustrates the appearance of a periodic, triangular brightness distribution on a computer screen, and FIG. 3b shows the brightness as a function of distance across the screen.

FIG. 4a illustrates the transmission of a slide prepared by photographing the computer screen of FIG. 3a, and FIG. 4b shows the transmission function versus distance across the slide.

FIG. 5a illustrates the appearance of a periodic, non-linear brightness distribution on a computer screen, and FIG. 5b shows the brightness as a function of distance across the screen.

FIG. 6 illustrates the linearity of the transmission function of a photographic slide prepared by photographing a non-linear brightness distribution on a computer screen of the type shown in FIG. 5a.

FIGS. 7a, 7b, and 7b illustrate the transmission functions of three photographic slides of the invention where each of the transmission functions is triangular with the same period and the functions are offset from one another by one third of a period.

FIG. 8 is a plot of a light pattern suitable for use in determining three dimensional configurations which can be produced using one or more of the photographic slides of the invention. In particular, this figure shows normalized intensity (vertical axis) versus a linear coordinate across a target plane or target object (horizontal axis).

The foregoing drawings, which are incorporated in and constitute part of the specification, illustrate various embodiments of the invention. As with the written description, these drawings are explanatory only and should not be considered as restrictive of the invention.

### DESCRIPTION OF THE PREFERRED EMBODIMENTS

As discussed above, the photographic slides of the present invention can be used in three-dimensional imaging systems and, in particular, in three-dimensional imaging systems in which desired light distribution patterns are formed on a target plane or object.

Systems of this type using a rainbow color pattern have been described in, for example, the Geng article in Optical Engineering discussed above. Sequential illumination with three spatial patterns of three different colors is described in U.S. patent Publication No. US 2003/0223083, also discussed above. Sequential illumination with a series of spatial light patterns having substantially the same spectral content is disclosed in U.S. application Ser. No. ______ entitled “Methods and Apparatus for Determining Three Dimensional Configurations”, Docket No. 58777US002, which is being filed simultaneously herewith. The contents of this co-pending application are incorporated herein by reference.

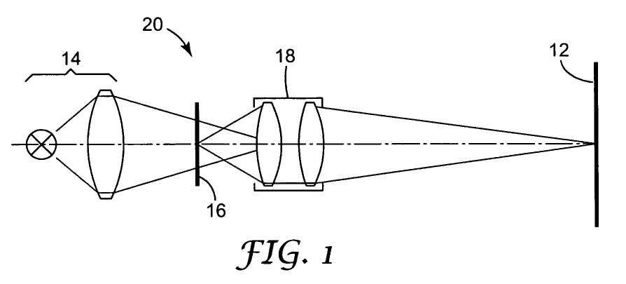

An optical layout suitable for use in producing a light pattern on a portion of an object whose three dimensional configuration is to be determined is shown in FIG. 1. As shown therein, optical system 20 comprises an illumination system 14, a photographic slide 16, and a projection lens assembly 18 containing one or more lens elements organized into one or more lens units. Illumination system 14 can comprise one or more light sources and suitable optics for forming images of the light sources in the entrance pupil of the projection lens. The spacing between slide 16 and projection lens 18 is selected so that the lens forms an image of the slide on target plane 12.

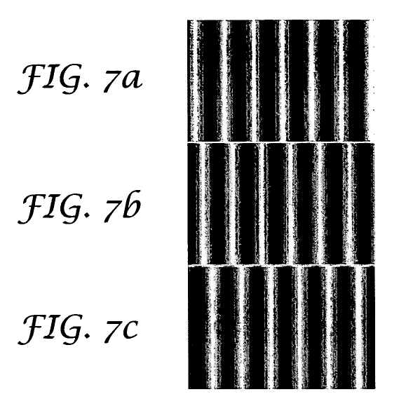

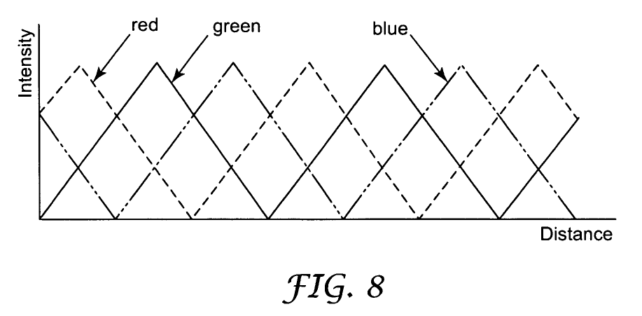

To accurately determine three dimensional configurations using an optical system of the type shown in FIG. 1, slide 16 must have a light transmission function which produces a light intensity pattern on the target object suitable for analysis to determine the shape of the object. Examples of the types of transmission functions/light intensity patterns that can be used for this purpose are illustrated in FIGS. 7 and 8.

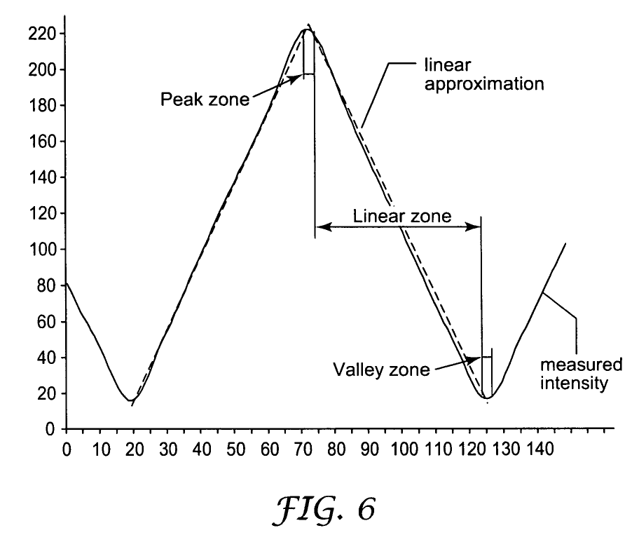

In particular, FIG. 7 shows a set of three photographic slides prepared in accordance with the invention where each slide has a periodic transmission function having the same period and structure (i.e., triangular within each period in this embodiment), with the transmission functions of the three slides being shifted relative to one another by one third of a period. As discussed more fully below in connection with FIG. 6, the transmission functions of these slides are linear to within 2 percent for at least 90 percent of each period.

FIG. 8 shows an intensity pattern which can be produced using the photographic slides of FIG. 7. In this case, it is assumed that one of the slides produces a red pattern, a second produces a green pattern, and the third a blue pattern. Such coloring of the patterns can be produced through the use of light sources of different colors and/or by providing the slides with different spectral transmission properties.

As can be seen in FIG. 8, the light pattern essentially is repeatable overlapping of the three primary colors (red, green and blue) on the target. The periods of these three primary colors are the same and are displaced relative to each other at ⅓ of a period, where the period for every primary color consists of a linear change of intensity from a minimum intensity, e.g., zero intensity, to a maximum intensity and back to the minimum intensity. The light intensity patterns and the transmission functions which generate the patterns thus comprise a plurality of pieces each of which is substantially linear. These substantially linear pieces give the overall pattern a linearity suitable for use in determining the three-dimensional configuration of an object, such as, a patient's tooth.

Although the three colors are shown illuminating the object simultaneously in FIG. 8, the illumination can be sequential if desired. Also, for sequential illumination, the three patterns can have a single color (e.g., red) or can comprise three gray scales shifted in phase.

Rather than using three slides to produce the intensity pattern of FIG. 8, a single photographic slide can be used which has three overlapping transmission functions, namely, a red transmission function, a green transmission function, and a blue transmission function, each of which is periodic with the same period and the same structure (e.g., triangular within each period). To achieve the intensity distribution of FIG. 8, the transmission functions are phase shifted relative to one another by one-third of a period. Again, for at least 85 percent of each period and preferably for at least 90 percent of each period, each of the transmission functions is linear to within 3 percent and preferably to within 2 percent.

The photographic slides of the invention can be prepared using an iterative technique wherein an image on a computer screen is photographed on film, the film is developed, the transmission function of the developed film is measured and compared with a desired transmission function, the image on the computer screen is modified based on the comparison, and the process is repeated as many times as necessary (e.g., 3-5 times) until the measured transmission function satisfies a user-specified criterion, e.g., substantial linearity. If the photographic slide is to contain more than one transmission function, e.g., a red transmission function, a green transmission function, and a blue transmission function, then the photographing, measuring, and image modifying steps can be performed separately for each of the desired transmission functions. If desired, only the measuring and image modifying steps can be performed separately with the exposing step being performed simultaneously for the various brightness patterns or a subset thereof. A display of multiple brightness patterns on a computer screen creates a complicated image. Displaying and exposing the film one brightness pattern at a time makes for simpler images and thus can facilitate a user's ability to follow changes to the brightness patterns as the process is iterated.

The slide preparation process can be performed entirely with commercially available products and processes, e.g., a standard computer monitor, standard photographic equipment suitable for photographing a computer screen, standard photographic film (color or black and white), and a commercially available development process, such as those available to retail consumers. In this way, photographic slides having desired transmission functions can be produced inexpensively, the cost being many times less than that involved in producing a LVWF. Of course, customized equipment and/or processes can be used in the practice of the invention if desired.

As just one example of the type of camera equipment and film which can be used in the practice of the invention, photographic slides having a high level of linearity (see FIG. 6) have been produced using a NIKON SLR camera and KODAK ELITE CHROME color film. The computer monitor in this case was of the CRT type, although other types of monitors, e.g., LCD monitors, can be used if desired.

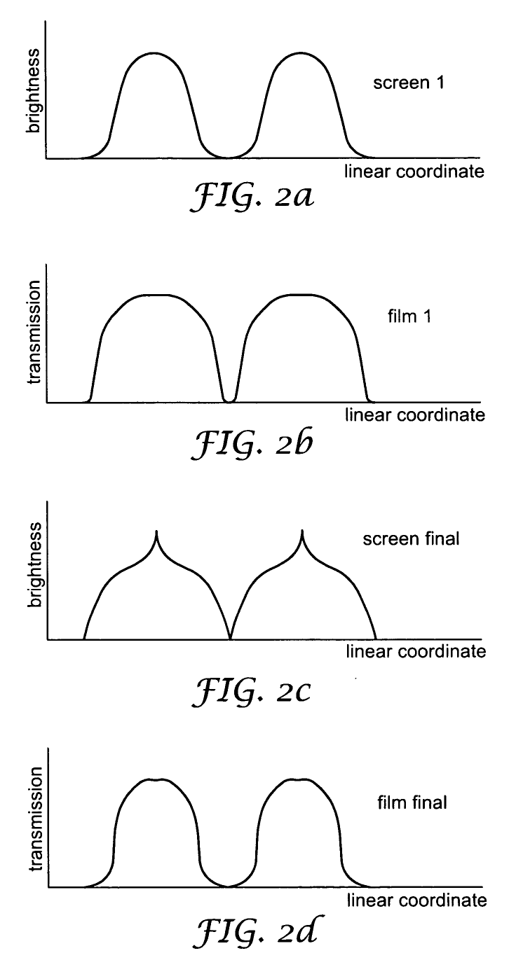

FIG. 2 illustrates the process aspects of the invention for a sinusoidal transmission function, although any other transmission function could be produced as desired. FIG. 2a shows an initial computer screen brightness pattern for use with positive photographic film, namely, a brightness pattern which has a sinusoidal spatial variation, i.e., the ultimate transmission pattern which is desired. If negative photographic film were used, the initial brightness pattern would be the reverse of the desired sinusoidal pattern.

FIG. 2b shows the type of measured transmission function that results from photographing the brightness pattern of FIG. 2a with commercial photographic film and then developing the exposed film. The non-linear response of the photographic film is evident in this figure, with the transmission function being quite different from the desired sinusoidal pattern.

FIGS. 2c and 2d show the final screen brightness pattern and film transmission function achieved by iteratively adjusting the image on the screen until the measured transmission function is sufficiently close to the desired transmission function. As can be seen in these figures, the image displayed on the computer screen needs to be substantially different from a sinusoidal pattern in order to produce a transmission function which is sinusoidal.

The images on the computer screen which are photographed to produce the slides of the invention can be generated by controlling the color of individual pixels (individual dots) of the screen. The color of each pixel of a computer monitor is generally described as a RGB(AR, AG, AB) function, where AR, AG, and AB are integer numbers in the range from 0 to 255, with the intensity of each primary color being proportional to this integer. Equal values for AR, AG, and AB create different gray levels. The relationship between different colors and different RGB arguments is shown in Table 1.

If negative photographic film is used, additive colors for the RGB function can be used. Specifically, in this case, the brightness function for the pixels of the screen can be RGB(255-AR, 255-AG, 255-AB), where AR, AG, AB are the same arguments as in Table 1. When a brightness distribution of this type is photographed with negative color film, the developed negative slide (reversed color) will produce the desired color distribution on the target object.

Whichever brightness function is used, the light emitted by individual pixels is controlled using a software program with function calls capable of specifying RGB values for individual pixels. For example, the software program can be written in Borland's DELPHI language, where the command for assigning individual pixel colors and intensities is: Canvas.Pixels[m, n]:=RGB(AR, AG, AB), where m(n) is the row(column) of the pixel and AR,AG,AB are integer values between 0 and 255.

The program can, for example, scan across the pixels of the screen one row at a time specifying color/intensity values for each pixel. As is typical, the program will normally be designed to write and read color/intensity information from a memory file. The program can suppress the standard WINDOWS borders and caption area and can allow for variations in the number of periods per picture and the size and location of the pattern on the computer screen, including picture shifting within a window to achieve phase shifting.

Other approaches now known or subsequently developed for controlling the brightness distribution of a computer screen can be used in the practice of the invention as desired. As just one example, other programming languages besides DELPHI, such as C⁺⁺, can be used to program a monitor to display a desired brightness pattern.

When black and white film is used, the brightness patterns on the computer screen can be generated by varying one and only one of the red, green, and blue values for the pixels of the screen. Similarly, for color film, the brightness patterns on the computer screen can be generated by varying one and only one of the red, green, and blue values for the pixels of the screen. Alternatively, in either case, the brightness patterns can be generated by varying red, green, and blue values for the pixels of the screen simultaneously.

As an example, the iterative adjustments to the brightness pattern can be made in accordance with an expression of the form:
I_{n,m}(k+1)=I_{n,m}(k)+Δ_{n,m}(I_{n,m}(k), t_{n,m}(k), T_{n,m}) (1)
where:
(i) n,m represents coordinates of a pixel of the computer screen,
(ii) I_{n,m}(k) represents brightness of the n,m pixel for the k iteration of the process,
(iii) t_{n,m}(k) represents the value of the measured transmission function after the k iteration at the location on the slide corresponding to the n,m pixel,
(iv) T_{n,m} represents the value of the desired transmission function at the location on the slide corresponding to the n,m pixel, and
(v) I_{n,m}(k+1) represents brightness of the n,m pixel for the k+1 iteration.

Δ_{n,m}(I_{n,m}(k), t_{n,m}(k), T_{n,m}) can, for example, be of the form:
Δ_{n,m}(I_{n,m}(k), t_{n,m}(k), T_{n,m})=(T_{n,m}/t_{n,m}(k)−1)·I_{n,m}(k). (2)

The I_{n,m}(k+1) values can be normalized so that the maximum of those values equals the maximum brightness available for a pixel, e.g., the I_{n,m}(k+1) values can be normalized so that the minimum and maximum In,m(k+l) values after normalization are 0 and 255, respectively. Other values can be selected if desired.

The t_{n,m}(k) values of these equations can be determined using various equipment known in the art for measuring transmission functions of photographic film. A suitable device is the MTF measurement system sold by Optics 1, Inc., 3050 E. Hillcrest Drive, Westlake Village, Calif. 91362, where light projected through a slide can be collected and analyzed to determine the slide's transmission function.

Equations (1) and/or (2), or equivalent equations, can be implemented using a software program which uses I_{n,m}(k), t_{n,m}(k), and T_{n,m} as inputs and generates I_{n,m}(k+1) as an output. Such programs can be written in various programming languages known in the art and designed to run on, for example, a desktop computer.

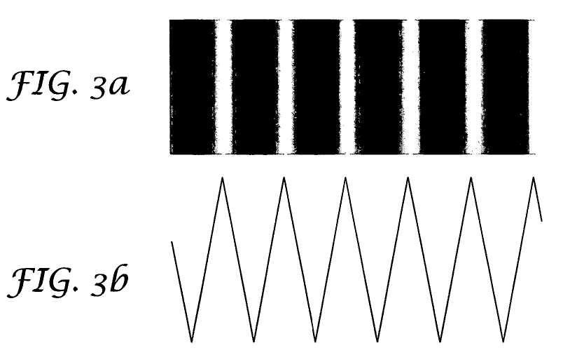

FIGS. 3 through 7 illustrate one application of the invention wherein photographic slides are produced having transmission functions which (i) comprise a plurality of periods and (ii) satisfy the criterion that for at least 85 percent of each period (specifically, for at least 90 percent in this case), the transmission function is linear to within 3 percent (specifically, to within 2 percent in this case). The 85%/3% combination is sufficient to provide light intensity patterns suitable for three-dimensional imaging, while the 90%/2% combination ensures a high level of accuracy over the entire area of the object illuminated by the intensity patterns.

FIG. 3 shows a suitable initial brightness pattern for producing such slides. In particular, FIG. 3a illustrates the appearance of a periodic, triangular brightness distribution on a computer screen, and FIG. 3b shows the brightness as a function of distance across the screen.

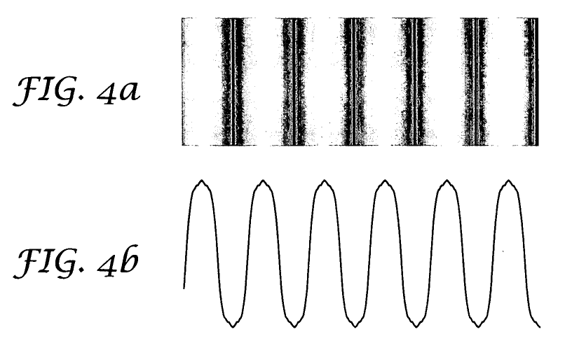

FIG. 4a illustrates the transmission of a slide prepared by photographing the computer screen of FIG. 3a, and FIG. 4b shows the transmission function of this slide as a function of distance across the slide. As can be seen in this figure, the slide's transmission function is linear over some parts of each period, i.e., the central portion of each rising and falling portion, but those parts do not satisfy the requirement that the transmission function is linear over 85 percent of each period to within 3 percent.

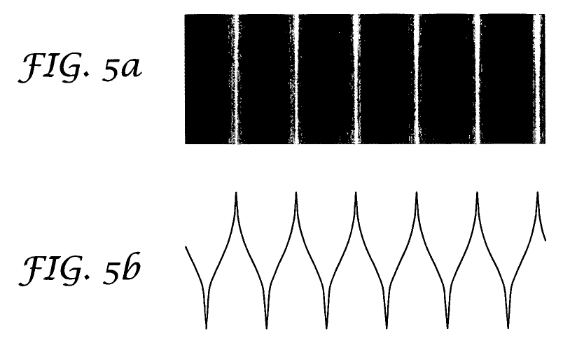

FIG. 5a illustrates the appearance on a computer screen of an adjusted brightness distribution obtained using equations (1) and (2) above, and FIG. 5b shows the brightness of the pattern as a function of distance across the screen. This brightness distribution is clearly non-linear. However, as shown in FIGS. 6 and 7, when photographed, the brightness distribution of FIG. 5a produces a film transmission function which is linear to within 3 percent over more than 85 percent of each period.

In particular, FIG. 6 shows the measured intensity of light passing through the developed photographic slide for one representative period, the other periods of the slide exhibiting substantially the same performance. The measured intensity range for this slide was from 16 to 222 units (i.e., a dynamic range of 206 units).

The straight dashed lines of FIG. 6 are linear approximations to the measured intensity. These linear approximations can be obtained using, for example, a least squares fit. Other approaches for fitting a straight line approximation to the data can be used if desired, including simple visual fitting, provided such fitting is sufficiently accurate to show that a desired performance criterion (e.g., linearity to within 3 percent over 85 percent of a period) is satisfied.

As can be seen in FIG. 6, the measured intensity differs most significantly from the linear approximation in the areas marked peak zone and valley zone. These zones, however, represent much less than 85 percent of a period, which for the scale of FIG. 6 is approximately 106 units along the horizontal axis. In particular, the peak zone has a width of approximately 3 horizontal units and the valley zone has a width of approximately 3 horizontal units, so that together these zones have a width of approximately 6 horizontal units which is less than 6 percent of the length of a period, i.e., 106 units in this case.

Linearity can be defined as the deviation of the measured intensity values from the linear approximations. An analysis of the data of FIG. 6 showed that the deviation from the straight lines of this figure, which in this case were obtained by visual fitting, was equal to 2 horizontal units for the area marked linear zone on the declining portion of the curve plus the corresponding area (not marked) for the ascending portion of the curve.

As discussed above, the period of the intensity function is approximately 106 linear units. Accordingly, for the linear zones, the transmission function of the slide is within 2 percent of a straight line (2/106×100=1.9%). As indicated above, the linear zones comprise more than 85 percent of a period. As also indicated above, substantially the same performance was observed for each of the periods making up the usable region of the slide. Accordingly, the slides of FIGS. 6 and 7, prepared using the procedure illustrated in FIGS. 3-5, satisfy the criterion of being linear to within 3 percent over 85 percent of at least two periods. The slides also satisfy the more stringent criterion of being linear to within 2 percent over at least 90 percent of each period.

Although specific embodiments of the invention have been described and illustrated, it is to be understood that a variety of modifications which do not depart from the scope and spirit of the invention will be evident to persons of ordinary skill in the art from the foregoing disclosure.

TABLE 1

| AR | AG | AR | Color |
|---|---|---|---|
| 0 | 0 | 0 | black |
| 255 | 255 | 255 | white |
| 0 | 0 | 255 | 100% blue |
| 0 | 255 | 0 | 100% green |
| 255 | 0 | 0 | 100% red |
| 51 | 0 | 0 | 20% red |

1. A method for producing a photographic slide using a computer screen having a plurality of pixels, said photographic slide comprising a user-specified type of photographic film developed by a user-specified developing process, said method comprising:
(A) generating a brightness pattern on the computer screen by selecting red, green, and blue brightness values for the pixels of the screen;
(B) exposing the user-specified type of photographic film to the brightness pattern using a user-specified set of exposure conditions;
(C) developing the exposed photographic film using the user-specified developing process;
(D) measuring the transmission function of the exposed and developed photographic film;
(E) comparing the measured transmission function to a desired transmission function and generating an adjusted brightness pattern on the computer screen based on said comparison;
(F) iterating steps (B) through (E) using the adjusted brightness pattern of step (E) as the brightness pattern of step (B) to identify a final brightness pattern for which the difference between the measured transmission function and the desired transmission function satisfies a user-specified criterion; and
(G) using the final brightness pattern to produce the photographic slide.

2. The method of claim 1 wherein the user-specified type of photographic film is positive film and the brightness pattern of step (A) has the shape of the desired transmission function.

3. The method of claim 1 wherein the user-specified type of photographic film is negative film and the brightness pattern of step (A) has the shape of the reverse of the desired transmission function.

4. The method of claim 1 wherein the brightness pattern is adjusted in accordance with an expression of the form:
I_{n,m}(k+1)=I_{n,m}(k)+Δ_{n,m}(I_{n,m}(k), t_{n,m}(k), T_{n,m})
where:
(i) n,m represents coordinates of a pixel of the computer screen,
(ii) I_{n,m}(k) represents brightness of the n,m pixel for the k iteration,
(iii) t_{n,m}(k) represents the value of the measured transmission function after the k iteration at the location on the slide corresponding to the n,m pixel,
(iv) T_{n,m} represents the value of the desired transmission function at the location on the slide corresponding to the n,m pixel, and
(v) I_{n,m}(k+1) represents brightness of the n,m pixel for the k+1 iteration.

5. The method of claim 4 where
Δ_{n,m}(I_{n,m}(k), t_{n,m}(k), T_{n,m})=(T_{n,m}/t_{n,m}(k)−1)·I_{n,m}(k).

6. The method of claim 4 where the I_{n,m}(k+1) values are normalized so that the maximum of said values equals the maximum brightness available for a pixel.

7. The method of claim 6 wherein the minimum and maximum I_{n,m}(k+1) values after normalization are 0 and 255, respectively.

8. The method of claim 1 wherein the user-specified type of photographic film is black and white film and the brightness patterns on the computer screen are generated by varying one and only one of red, green, and blue values for the pixels of the screen.

9. The method of claim 1 wherein the user-specified type of photographic film is color film and the brightness patterns on the computer screen are generated by varying one and only one of red, green, and blue values for the pixels of the screen.

10. The method of claim 1 wherein the user-specified type of photographic film is color film and the brightness patterns on the computer screen are generated by varying red, green, and blue values for the pixels of the screen simultaneously.

11. The method of claim 1 wherein:
(i) the user-specified type of photographic film is color film,
(ii) the desired transmission function comprises a desired red transmission function, a desired green transmission function, and a desired blue transmission function, and
(iii) for each iteration:
(a) the user-specified type of photographic film is exposed in step (B) to red, green, and blue brightness patterns,
(b) separate red, green, and blue transmission functions are measured for the developed film in step (D),
(c) separate comparisons and adjusted red, green, and blue brightness patterns are generated in step (E), and
(d) separate red, green, and blue final brightness patterns are identified in step (F).

12. The method of claim 11 further comprising using the red, green, and blue final brightness patterns to produce a plurality of photographic slides.

13. The method of claim 1 wherein the desired transmission function comprises at least two periods.

14. The method of claim 13 wherein the desired transmission function is triangular within each period.

15. The method of claim 13 wherein the user-specified criterion requires the measured transmission function to be linear to within 3 percent for at least 85 percent of each period.

16. The method of claim 13 wherein the user-specified criterion requires the measured transmission function to be linear to within 2 percent for at least 90 percent of each period.

17. The method of claim 1 further comprising using the final brightness pattern to produce a plurality of photographic slides.

18. A photographic slide having a measured transmission function which:
(i) comprises at least two periods; and
(ii) for at least 85 percent of each period, is linear to within 3 percent.

19. The photographic slide of claim 18 wherein for at least 90 percent of each period, the measured transmission function is linear to within 2 percent.

20. The photographic slide of claim 18 wherein the measured transmission function is triangular within each period.

21. A photographic slide having a red measured transmission function, a green measured transmission function, and a blue measured transmission function, each of which:
(i) comprises at least two periods; and
(ii) for at least 85 percent of each period, is linear to within 3 percent.

22. The photographic slide of claim 21 wherein for at least 90 percent of each period, each measured transmission function is linear to within 2 percent.

23. The photographic slide of claim 21 wherein:
(a) the periods of the red, green, and blue measured transmission functions are the same; and
(b) the red, green, and blue measured transmission functions are phase shifted by one-third of a period.

24. The photographic slide of claim 21 wherein the measured red. green, blue transmission functions are triangular within each period.

25. A set of three photographic slides wherein:
(A) each slide has a measured transmission function which:
(i) comprises at least two periods; and
(ii) for at least 85 percent of each period, is linear to within 3 percent;
(B) the periods of the three slides are the same; and
(C) the measured transmission functions of the slides are phase shifted by one-third of a period.

26. The set of photographic slides of claim 25 wherein for at least 90 percent of each period, the measured transmission function of each slide is linear to within 2 percent.

27. The set of photographic slides of claim 25 wherein the measured transmission functions of the slides are triangular within each period.
